(19) United States
(12) Patent Application Publication
(10) Pub. No.: US 2010/0329831 A1
(43) Pub. Date: Dec. 30, 2010

(54) VEHICLE MOUNTABLE LIFT

(76) Inventors: Lin O. Tornese, Terre Haute, IN (US); Russell G. Ferrell, Terre Haute, IN (US)

Correspondence Address: Woodard, Emhardt, Moriarty, McNett & Henry LLP, 111 Monument Circle, Suite 3700, Indianapolis, IN, 46204-5137, US

(21) Appl. No.: 12/826,953

(22) Filed: Jun. 30, 2010

Related U.S. Application Data
(60) Provisional application No. 61/221,785, filed on Jun. 30, 2009.

(51) Int. Cl. B60P 1/44; B60P 1/00; A61G 3/06

(52) U.S. Cl. 414/544

(57) ABSTRACT

Disclosed is a lift for use with a vehicle that includes a lifting surface, a telescoping assembly that telescopes horizontally further than the length of the lifting surface, a pair of moving pivots operatively coupled to an actuator and carried by the telescoping assembly, a pair of linkage rods pivotally connected between the lifting surface and the telescoping assembly by fixed pivot points and a second pair of linkage rods pivotally connected between the moving pivots and lifting surface, where the second pair of linkage rods are connected to the lifting surface by fixed pivot points, where the lifting surface is suspended from the telescoping assembly by the first and second pairs of linkage rods, where the lifting surface is raised and lowered by moving the pair of moving pivots with the actuator and where the telescoping assembly allows the lifting surface to move into and out of the vehicle.

This application claims the benefit of U.S. Provisional Application No. 61/221,785 filed Jun. 30, 2009, which is hereby incorporated by reference.

### BRIEF DESCRIPTION OF THE DRAWINGS

FIG. 1 illustrates a perspective view of a vehicle mountable lift extended from the vehicle.

FIG. 2 illustrates a perspective view of a lift assembly, a component of the vehicle mountable lift of FIG. 1.

FIG. 3 illustrates a simplified side elevational view of the vehicle mountable lift of FIG. 1.

FIG. 4 illustrates a partial side view of the lift assembly of FIG. 2 illustrating a lift sequence.

FIG. 5 illustrates an end elevational view of an embodiment of a vehicle mountable lift holding a gurney.

FIG. 6 illustrates a partial end elevational view of an alternate embodiment of the FIG. 5. vehicle mountable lift.

FIG. 7 illustrates a partial end elevational view of an alternate embodiment of the FIG. 5. vehicle mountable lift.

### DETAILED DESCRIPTION OF THE DRAWINGS

For the purpose of promoting an understanding of the claims, reference will now be made to certain embodiments thereof and specific language will be used to describe the same. It will nevertheless be understood that no limitation of the scope of this disclosure and the claims is thereby intended, such alterations, further modifications and further applications of the principles described herein being contemplated as would normally occur to one skilled in the art to which this disclosure relates. In several figures, where there are the same or similar elements, those elements are designated with the same or similar reference numerals.

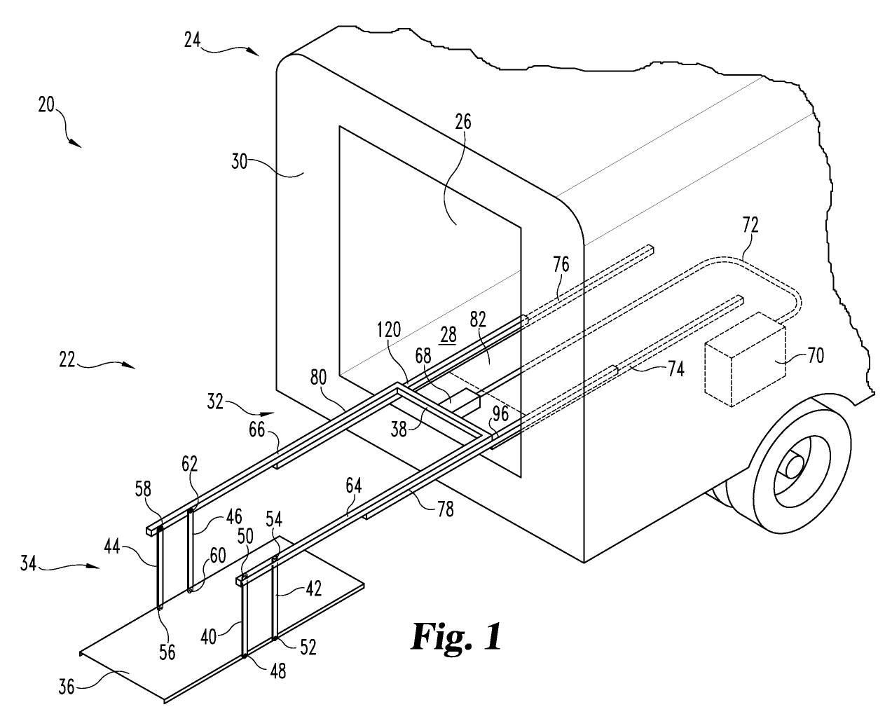

Referring now to FIG. 1 system 20 is illustrated. System 20 includes vehicle mountable lift 22 mounted on vehicle 24. Vehicle 24 includes cargo bay 26, floor 28 and enclosure 30. Vehicle mountable lift 22 includes telescoping assembly 32 and lift assembly 34. Vehicle mountable lift 22 is configurable and arrangable to be mounted in many types of vehicles for a variety of purposes including mounting in an ambulance to lift and load patients and gurneys or cargo vans and semi-trailers to lift and load cargo including individual packages and pallets. As illustrated in FIG. 1, vehicle mountable lift 22 is mounted in an ambulance. In the illustrated embodiment, vehicle mountable lift 22 is constructed and arranged to lift a minimum load of one-thousand two-hundred pounds.

Lift assembly 34 includes lifting surface 36, frame 38, linkage rods 40, 42, 44 and 46 and supports 64 and 66. Linkage rod 40 is coupled to lifting surface 36 at fixed pivot 48 and to frame 38 at fixed pivot 50. Linkage rod 42 is coupled to lifting surface 36 at fixed pivot 52 and to frame 38 at moving pivot 54. Linkage rod 44 is coupled to lifting surface 36 at fixed pivot 56 and to frame 38 at fixed pivot 58. Linkage rod 46 is coupled to lifting surface 36 at fixed pivot 60 and to frame 38 at moving pivot 62.

Fixed pivots 48, 52, 56 and 60 are “fixed” in position relative to lifting surface 36 so that they move in unison with lifting surface 36. Fixed pivots 50 and 58 and “fixed” in position relative to supports 64 and 66 respectively so that they move in unison with lift assembly 34. Moving pivots 54 and 62 are constructed and arranged to linearly move along supports 64 and 66 respectively of frame 38. They otherwise move in unison with lift assembly 34. All pivots 48, 50, 52, 54, 56, 58, 60 and 62 permit respective linkage rods 40, 42, 44 and 46 to turn about the pivot point but otherwise constrain movement.

Actuator 68 is mechanically coupled to moving pivots 54 and 62 so that actuator 68 is operational to move moving pivots 54 and 62 linearly along supports 64 and 66 respectively. Actuator 68 moves moving pivots 54 and 62 with actuator 68 powered by power source 70 which is coupled to actuator 68 by conduit 72. Power source 70 provides the power for operating actuator 68 by generating and/or storing power. In one embodiment, actuator 68 may be a hydraulic motor with power source 70 being a hydraulic pump and conduit 72 being a flexible hydraulic line. In another embodiment, actuator 68 may be an electric motor with power source 70 being either a generator or an electric battery and conduit 72 being an electrical wire. In yet another embodiment, actuator 68 could be a pneumatic motor with power source 70 being a compressor and conduit 72 being a pneumatic hose.

Telescoping assembly 32 includes fixed members 74 and 76, intermediate members 96 and 120 and moving members 78 and 80. Fixed members 74 and 76 can be coupled to floor 28 with tray 82 positioned between fixed members 74 and 76 on the floor 28. Moving members 78 and 80 carry supports 64 and 66 and frame 38 (thereby carrying lift assembly 34). Intermediate members 96 and 120 allow moving members 78 and 80 to extended beyond fixed members 74 and 76 (and floor 28) so that lifting surface 36 can be lowered below floor 28 (and subsequently raised back above floor 28). Tray 82 contains and guides conduit 72 during extension and retraction of telescoping assembly 32. While not specifically illustrated, telescoping assembly 32 may optionally include locking mechanisms that prevent unintended extension or retraction of telescoping assembly 32.

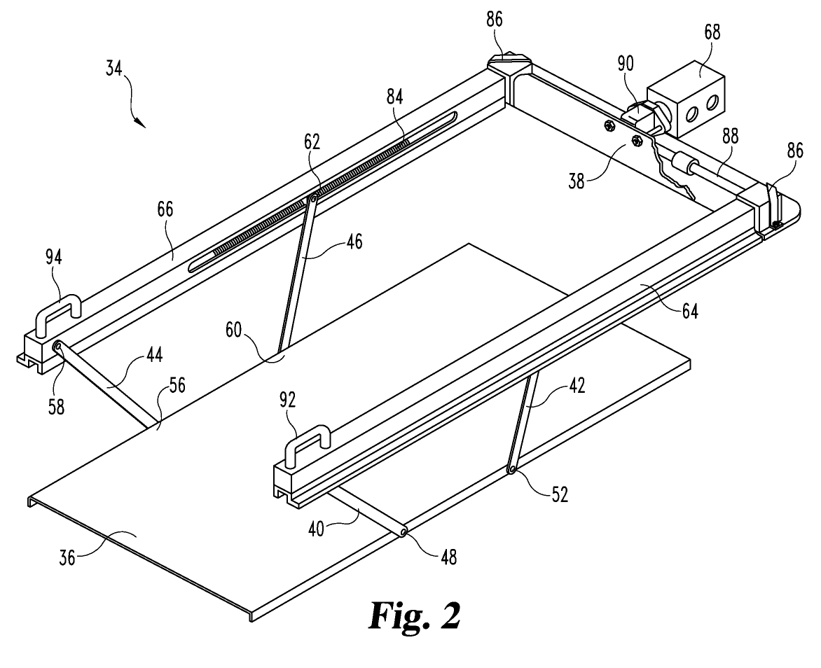

Referring now to FIG. 2, an embodiment of lift assembly 34 is illustrated. In addition to the features described above with regard to FIG. 1, the lift assembly shown in FIG. 2 includes power screw 84 coupled to actuator 68 by a series of mechanical connections including 90-degree connector 86, connecting shaft 88 and T-connector 90. (Connecting shaft 88 is shown on a cutaway on the right side of the assembly while power screw 84 is shown on the left side of the assembly. It should be understood that there is a second power screw contained in support 64 with a comparable connecting rod between 90-degree on the left side of T-connector 90 that is obscured by frame 38 in FIG. 2.) The lift assembly illustrated in FIG. 2 also includes handles 92 and 94 that permit manual actuation of telescoping assembly 32 when lift assembly 34 is attached thereto. Alternative embodiments can use other power linkages to couple actuator 68 to the power screws including power screw 84.

In an alternative embodiment, one or more linear actuators such as hydraulic cylinders can replace power screw 84, actuator 68, 90-degree connector 86, connecting shaft 88 and T-connector 90. Such linear actuators could be positioned directly in supports 64 and 66 and coupled to moving pivots 54 and 62.

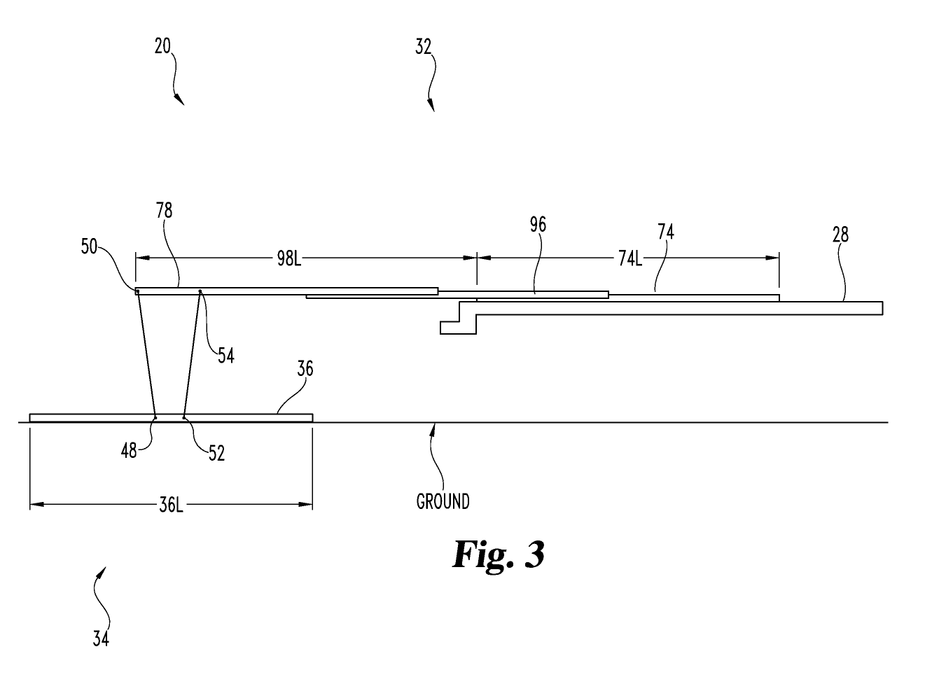

Referring now to FIG. 3, illustrated is a side view of system 20 showing telescoping assembly 32 in a fully extended position and lift assembly 34 in a fully lowered position. In the illustrated embodiment, telescoping assembly 32 includes fixed member 74 coupled to floor 28 with intermediate member 96 coupling moving member 78 to fixed member 74. As shown, intermediate member 96 permits moving member 78 to extend beyond fixed member 74. It should be understood that in a fully retracted position (not illustrated) the position of fixed member 74 and intermediate member 96 substantially overlap moving member 78 over floor 28. Whereas in the fully extended position illustrated, moving member 78 extends laterally completely beyond floor 28.

By way of example, FIG. 3 illustrates fixed member length 74L, telescoping length 98L and lifting surface length 36L. Telescoping length 98L is defined by the length that moving member 78 moves between the fully extended position and a fully stowed position (not illustrated). Length 98L is greater than length 74L and is also greater than length 36L thereby permitting lifting surface 36 to be moved completely beyond fixed member 74 (and floor 28).

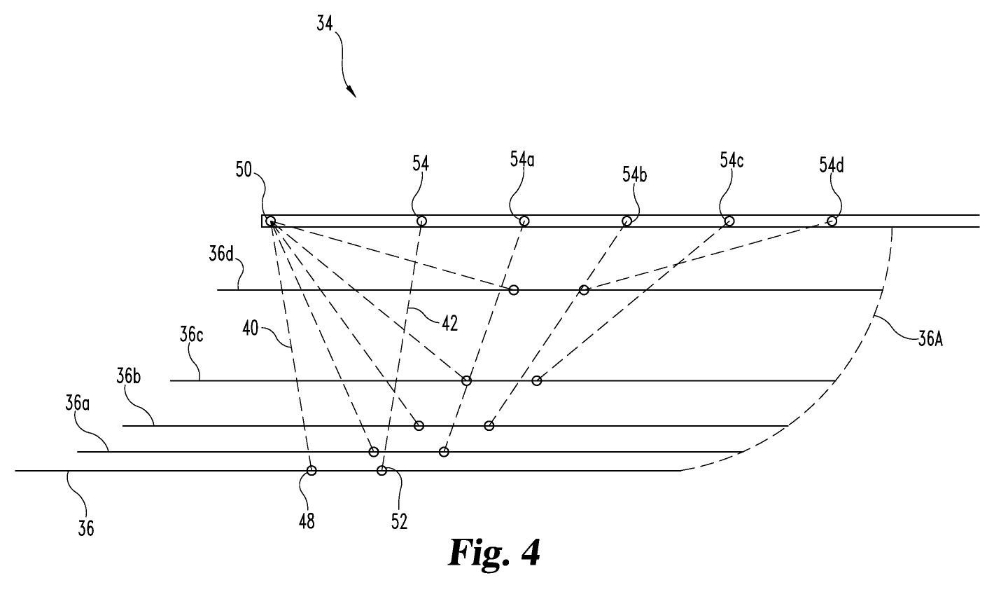

Referring now to FIG. 4, illustrated is a side view of lift assembly 34 illustrating subsequent lift positions. Included in FIG. 4 are fixed pivots 48, 50, 52, moving pivot 54 with linkage rod 40 between fixed pivots 48 and 50 and linkage rod 42 between fixed pivot 52 and moving pivot 54. Moving pivot 54 is illustrated in five sequential positions including 54, 54a, 54b, 54c and 54d. Similarly, lifting surface 36 is illustrated in five sequential positions including 36, 36a, 36b, 36c and 36d. As shown by these sequential positions, lifting surface 36 travels through a combination of horizontal and vertical movements traveling through circular arc 36A with a radius substantially equal to the distance between the center of fixed pivots 50 and 48. This sequence is reversed for lowering lifting surface 36.

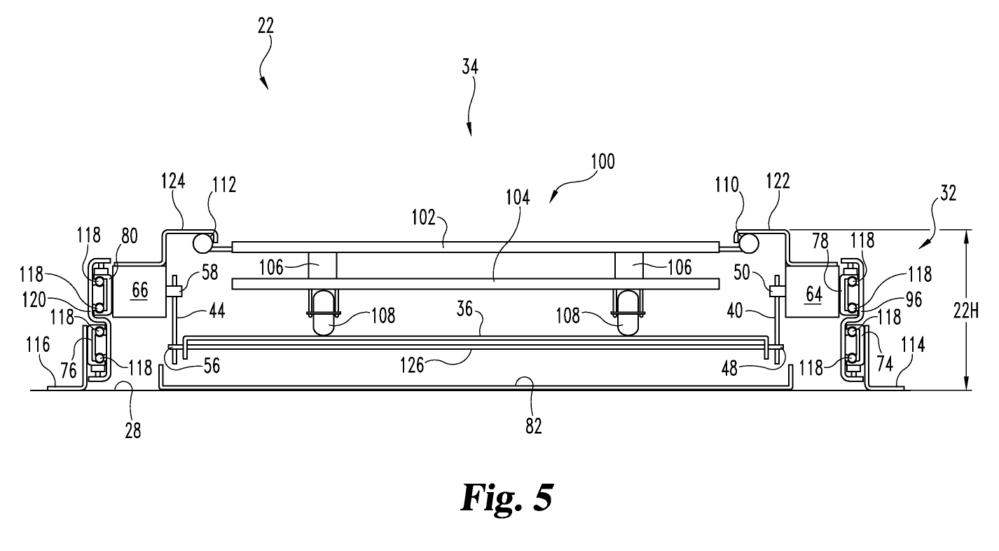

Referring now to FIG. 5, an embodiment of vehicle mountable lift 22 is illustrated constructed and arranged for use with gurney 100, for example, in an embodiment with vehicle mountable lift 22 mounted in an ambulance. Gurney 100 includes bed 102, base 104, collapsible frame 106, wheels 108 and side rails 110 and 112. The embodiment of vehicle mountable lift 22 illustrated in FIG. 5 includes fixed member 74 affixed to vehicle floor 28 by bracket 114 and fixed member 76 mounted to vehicle floor 28 by bracket 116. Fixed member 74 is coupled to intermediate member 96 through bearings 118 and fixed member 76 is coupled to intermediate member 120 through bearings 118. Intermediate member 96 is coupled to moving member 78 through bearings 118 and intermediate member 120 is coupled to moving member 80 through bearings 118. Moving member 78 is coupled to support 64 while moving member 80 is coupled to support 66. Fixed pivot 50 is coupled to support 64 and fixed pivot 58 is coupled to support 66. Lifting surface 36 is suspended over rod 126 between linkage rods 40 and 44. Fixed pivots 48 and 56 are defined by the ends of rod 126 with linkage rod 40 coupled between fixed pivot 50 and fixed pivot 48 and linkage rod 44 coupled between fixed pivot 58 and fixed pivot 56.

In one embodiment, clipper 122 is mounted on support 64 covering side rail 110 and clipper 124 is mounted on support 66 covering side rail 112. In this embodiment, clippers 122 and 124 are constructed and arranged to cover side rails 110 and 112, respectively, when gurney 110 is moved onto lifting surface 36. In an alternate embodiment (not illustrated), clippers 122 and 124 are mounted to vehicle 24 (such as to floor 28). In this embodiment, clippers 122 and 124 are constructed and arranged to cover side rails 110 and 112, respectively, when telescoping assembly 32 is retracted in vehicle 32. This embodiment permits side rails 110 and 112 to slide under clippers 122 and 124, respectively, when telescoping assembly 32 is either extended or retracted. In either embodiment, wheels 108 are positioned on top of lifting surface 36 with gurney 100 generally vertically constrained between lifting surface 36 and clippers 122 and 124. While not illustrated, in some embodiments lifting surface 36 may also include grooves or notches to secure wheels 108 from lateral movement either side-to-side or forward and backward or both on lifting surface 36. Tray 82 is positioned below vehicle mountable lift 22 on floor 28.

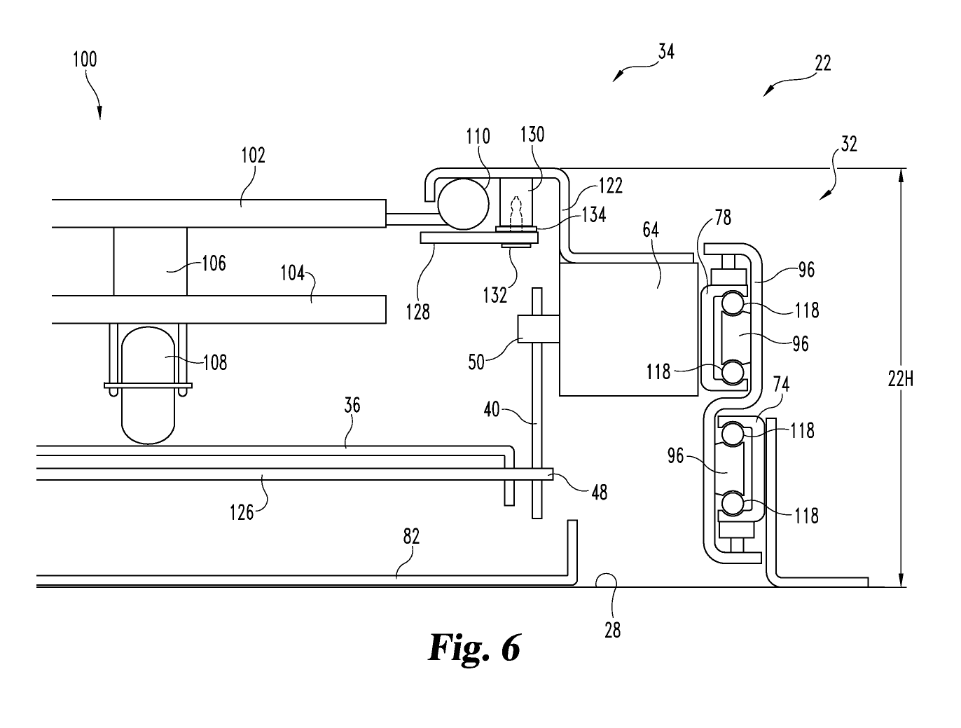

In yet another embodiment as illustrated in FIG. 6, clipper 122 may optionally include latch 128 coupled to clipper 122 and positioned under side rail 110. While not specifically illustrated, latch 128 is also coupled to clipper 124 and positioned under side rail 112. Latch 128 is constructed and arranged to support side rails 110 and 112 from below, vertically capturing side rails 110 and 112 between latch 128 and clippers 122 and 124, respectively. In this embodiment, latch 128 supports and holds gurney 100 during loading and unloading operations. For example, in loading gurney 100 with a patient into a vehicle, telescoping assembly 32 is extended and lift assembly 34 is lowered. Gurney 100 is then positioned on lifting surface 35 and the height of frame 106 is adjusted so that side rails 110 and 112 are captured between their corresponding latches 128 and clippers 122 and 124. Once latches 128 are positioned under side rails 110 and 112, gurney 100 can be supported by latches 128, permitting frame 106 to be released so that base 104 and lift assembly 34 can be raised by actuator 68 as described above. The loading is then completed by retracting telescoping assembly 32, lift assembly 34, gurney 100 and the patient into the vehicle.

Subsequent unloading of gurney 100 and the patient from the vehicle is accomplished by extending telescoping assembly 32 so that lift assembly 34 (and gurney 100) are extended completely outside of the vehicle. Frame 106 can then be released to extend while lift assembly 34 lowers lifting surface 36 and base 104 to ground level. Frame 106 is then locked and gurney 100 is wheeled off lifting surface 36 with frame 106 extended at height.

In the illustrated embodiment, each latch 128 is attached to its corresponding clipper 122 and 124 through a base 130 and a pin 132. Latch 128 rotates about pin 132 in two positions including the illustrated position and a second position in which latch 128 is moved away from side rail 110 or 112 and the end of clipper 122 so that side rail 110 or 112 is no longer vertically captured. To facilitate this, spring washer 134 pushes latch 128 away from base 130 and base 130 and latch 128 include mating notches and protrusions that lock latch 128 in one of the two positions, with latch 128 rotatable between the two positions. In the illustrated embodiment, three latches 128 are attached to both clipper 122 and 124 along their length, with each latch rated at 250 lbs.

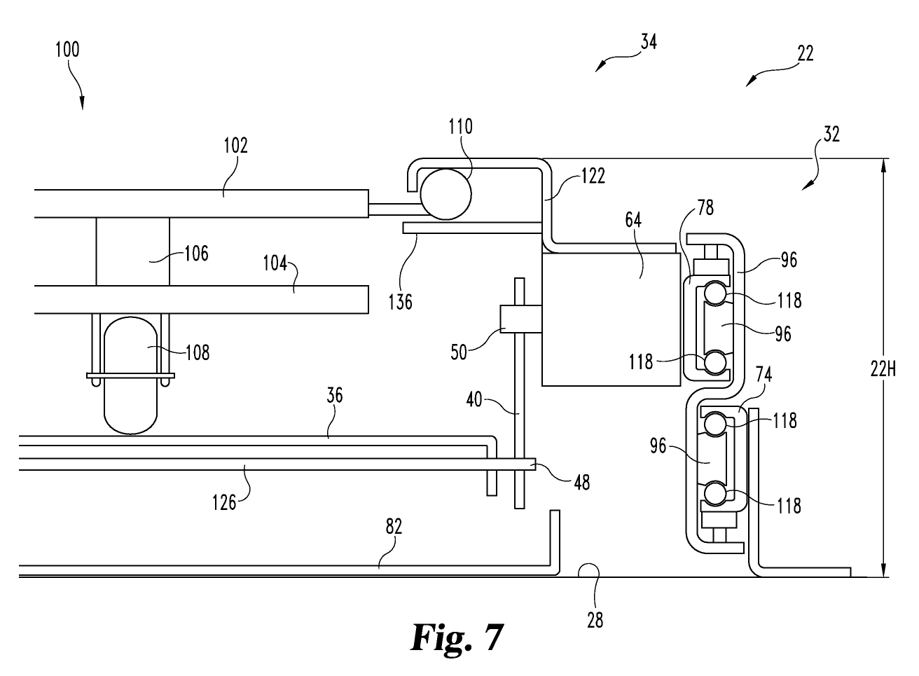

Referring now to FIG. 7, an alternative embodiment is illustrated where latch 128 is replaced with arm 136 extending under side rail 110 supporting side rail 110 from below vertically capturing side rail 110 between arm 136 and clipper 122. This same construction is applicable to clipper 124, although not specifically illustrated in FIG. 7. Arm 136 generally extends along the length of side rail 110 and is constructed and arranged to support gurney 100 during loading and unloading operations in the same way described above with respect to latch 128.

In the embodiments illustrated in FIGS. 5-7, vehicle mounted lift 22 is constructed and arranged to occupy less than eight inches of vertical space over floor 28. In particular, height 22H, represents the vertical distance between floor 28 and the “highest” part of vehicle mounted lift 22 over floor 28, is less than eight inches. This maximizes the utility of the space above floor 28 by minimizing the vertical intrusion of vehicle mounted lift 22.

The embodiments of vehicle mountable lift 22 illustrated in FIGS. 5-7 in a partial end view utilize a “DS Series” telescopic slide, available from ROLLON® Corp., 30A Wilson Drive, Sparta, N.J. 07871 and at www.rollon.com for telescoping assembly 32 including fixed member 74 (and 76), intermediate member 96 (and 120), moving member 78 (and 80) and bearings 118. Other embodiments can use various other configurations for telescoping assembly 32 including, but not limited to, other telescopic slides manufactured by ROLLON such as “DE” and “DBN” Series telescopic slides.

In the embodiments illustrated in FIGS. 5-7, lift assembly 34 is constructed and arranged to lift gurney 100 with a human patient from ground level to the level of floor 28. Telescoping assembly 32 is constructed in arranged to fully move gurney 100 and lifting surface 36 into and out of the ambulance.

In the embodiments illustrated in FIGS. 1-4, fixed pivots 48, 52, 56 and 60 are positioned proximate to the lateral center of lifting surface 36. In an alternative embodiment, fixed pivots 48 and 56 may be positioned near the rear end of lifting surface 36 with fixed pivots 52 and 60 positioned near the front end of lifting surface 36.

In such an embodiment, moving pivots 54 and 62 would be positioned proximate to fixed pivots 50 and 58 when lifting surface 36 is raised and moving pivots 54 and 62 would be moved away from fixed pivots 50 and 58 to lower lifting surface 36. In this embodiment, lifting surface 36 still is movable through a combination of horizontal and vertical movements traveling through a circular arc with a radius substantially equal to the distance between the center of fixed pivots 50 and 48.

In the embodiments described herein, linkage rods 40 and 44 are arranged as a first pair such that the movement of linkage rods 40 and 44 substantially mirror each other. Similarly, linkage rods 42 and 46 are arranged as a second pair such that the movement of linkage rods 42 and 46 substantially mirror each other. While linkage rods 40, 42, 44 and 46 move in unison due to the illustrated connections to lifting surface 36 at fixed pivot points 48, 52, 56 and 60, linkage rods 40 and 44 are free of any direct coupling to linkage rods 42 and 46 respectively.

While the disclosure has been illustrated and described in detail in the drawings and foregoing description, the same is to be considered as illustrative and not restrictive in character, it being understood that only the preferred embodiments have been shown and described and that all changes and modifications that come within the spirit of the disclosure are desired to be protected.

We claim:

1. A lift for use with a vehicle, the lift comprising:
a lifting surface having a horizontal length;
a telescoping assembly constructed and arranged to horizontally telescope further than the horizontal length, wherein the telescoping assembly is constructed and arranged to be coupled to the vehicle;
an actuator;
a pair of moving pivots operatively coupled to the actuator, wherein the pair of moving pivots are operatively carried by the telescoping assembly;
a first pair of linkage rods pivotally connected between the lifting surface and the telescoping assembly by fixed pivot points; and
a second pair of linkage rods pivotally connected between the lifting surface and the pair of moving pivots, wherein the second pair of linkage rods are connected to the lifting surface by fixed pivot points, wherein the first and second pairs of linkage rods suspend the lifting surface from the telescoping assembly, wherein the actuator is constructed and arranged to vertically raise and lower the lifting surface relative to the telescoping assembly by movement of the pair of moving pivots, and wherein, when coupled to the vehicle, the telescoping assembly is constructed and arranged to horizontally extend the lifting surface horizontally into and out of the vehicle.

2. The lift of claim 1, wherein the telescoping assembly comprises a fixed member, an intermediate member and a moving member, wherein the fixed member is constructed and arranged to be coupled to the vehicle and wherein the fixed member operatively carries the pair of moving pivots.

3. The lift of claim 1, wherein the telescoping assembly is constructed and arranged to be mounted to a floor of an interior compartment of the vehicle.

4. The lift of claim 3, wherein, in a stowed installed position, the lift is constructed and arranged to occupy less than eight inches of vertical space over the floor.

5. The lift of claim 3, wherein, in a stowed installed position, the lift is completely contained within the vehicle.

6. The lift of claim 1, wherein the telescoping assembly telescopes beyond a fixed member that is constructed and arranged to be coupled to the vehicle.

7. The lift of claim 1, further comprising first and second power screws operatively coupled to the actuator, wherein the actuator comprises a motor.

8. The lift of claim 7, further comprising a first nut threadingly engaged with the first power screw and second nut threadingly engaged with the second power screw and wherein the first and second nut carry the pair of moving pivots.

9. The lift of claim 1, wherein the actuator comprises a linear actuator.

10. The lift of claim 1, wherein the first pair of linkage rods are free of any direct coupling to the second pair of linkage rods.

11. The lift of claim 1, wherein the lifting surface moves through a circular arc when raised or lowered.

12. The lift of claim 1, wherein the lift is constructed and arranged to lift a minimum load of one-thousand two-hundred pounds.

13. In combination:
a vehicle comprising a cargo bay having a floor;
a lift comprising a lifting surface having a horizontal length;
a telescoping assembly constructed and arranged to horizontally telescope further than the horizontal length, wherein the telescoping assembly is coupled to the floor;
an actuator;
a pair of moving pivots operatively coupled to the actuator, wherein the pair of moving pivots are operatively carried by the telescoping assembly;
a first pair of linkage rods pivotally connected between the lifting surface and the telescoping assembly by fixed pivot points; and
a second pair of linkage rods pivotally connected between the lifting surface and the pair of moving pivots, wherein the first and second pairs of linkage rods suspend the lifting surface from the telescoping assembly, wherein the actuator is constructed and arranged to vertically raise and lower the lifting surface relative to the telescoping assembly by movement of the pair of moving pivots, and wherein the telescoping assembly is constructed and arranged to horizontally extend the lifting surface horizontally into and out of the vehicle.

14. The combination of claim 13, wherein the vehicle is an ambulance, the lifting surface is constructed and arranged to hold a gurney, wherein the lift is constructed and arranged to lift the gurney with a human patient from ground level to the floor and wherein the gurney and the patient can be fully moved into the ambulance by movement of the telescoping assembly.

15. The combination of claim 14, wherein the lift is constructed and arranged to occupy less than eight inches of vertical space over the floor in a stowed installed position.

16. The combination of claim 14, further comprising a plurality of latches operatively carried by the telescoping assembly, wherein the latches are constructed and arranged to support and hold the gurney during loading and unloading operations.

17. The combination of claim 13, wherein the lift is constructed and arranged to occupy less than eight inches of vertical space over the floor in a stowed installed position.

18. The combination of claim 13, wherein the vehicle is a semi-trailer, the lifting surface is constructed and arranged to hold cargo, wherein the lift is constructed and arranged to lift the cargo from ground level to the floor and wherein the cargo can be fully moved into the semi-trailer by movement of the telescoping assembly.

19. The combination of claim 13, wherein the first pair of linkage rods are free of any direct coupling to each other and wherein the second pair of linkage rods are free of any direct coupling to each other.

20. The combination of claim 13, wherein the telescoping assembly comprises a fixed member, an intermediate member and a moving member, wherein the fixed member is coupled to the floor and wherein the fixed member operatively carries the pair of moving pivots.

21. A kit comprising:
a lifting surface having a horizontal length;
a telescoping assembly constructed and arranged to horizontally telescope further than the horizontal length, wherein the telescoping assembly is constructed and arranged to be coupled to a vehicle;
an actuator;
a pair of moving pivots operatively coupled to the actuator, wherein the pair of moving pivots are operatively carried by the telescoping assembly;
a first pair of linkage rods pivotally connected between the lifting surface and the telescoping assembly by fixed pivot points; and
a second pair of linkage rods pivotally connected between the lifting surface and the pair of moving pivots, wherein the second pair of linkage rods are connected to the lifting surface by fixed pivot points, wherein the first and second pairs of linkage rods suspend the lifting surface from the telescoping assembly, wherein the actuator is constructed and arranged to vertically raise and lower the lifting surface relative to the telescoping assembly by movement of the pair of moving pivots, and wherein, when coupled to the vehicle, the telescoping assembly is constructed and arranged to horizontally extend the lifting surface horizontally into and out of the vehicle.
